(19) United States
(12) Patent Application Publication
(10) Pub. No.: US 2018/0220678 A1
(43) Pub. Date: Aug. 9, 2018

(54) COMPOSITIONS AND METHODS FOR INCREASING THE PALATABILITY OF DRY PET FOOD

(71) Applicant: NESTEC SA, VEVEY (CH)

(72) Inventors: Pascal Vanacker, AMIENS (FR); Lorcy Gwendal, AUBIGNY (FR); Catherine Kulker-Theron, Sans-en-Ameinois (FR); Chloé Breton, Summaga di Portogruaro (IT); Jean-Marie Laborbe, AMIENS (FR)

(21) Appl. No.: 15/947,318

(22) Filed: Apr. 6, 2018

Related U.S. Application Data
(63) Continuation of application No. 14/571,362, filed on Dec. 16, 2014.
(60) Provisional application No. 61/918,407, filed on Dec. 19, 2013.

(51) Int. Cl. A23K 20/10; A23K 20/105; A23K 50/42; A23K 40/20; A23K 40/25; A23K 40/30

(52) U.S. Cl. CPC A23K 20/10; A23K 20/105; A23K 40/30; A23K 40/20; A23K 40/25; A23K 50/42

(57) ABSTRACT

Compositions and methods are provided to increase the palatability of dry pet foods. The compositions comprise sorbic acid and/or a salt thereof. The compositions and methods increase the palatability without loss of crunchiness of the dry kibbles over an extended time period. The sorbic acid and/or salt thereof can be used in the base composition of the dry pet food and/or in a coating on the dry pet food, and the sorbic acid and/or salt thereof can be used without affecting the product structure.

### CROSS REFERENCE TO RELATED APPLICATIONS

This application is a continuation of U.S. Non-Provisional application Ser. No. 14/571,362 filed Dec. 16, 2014, which claims priority to U.S. Provisional Application No. 61/918,407 filed Dec. 19, 2013, the disclosures of which are incorporated herein by this reference.

### BACKGROUND

The present disclosure generally relates to pet foods. More specifically, the present disclosure relates to compositions and methods for increasing the palatability of dry pet foods.

Of the main pet food categories, namely dry, semi-moist, and wet, dry pet foods are perceived as the least palatable. The existing solutions rely on optimizing the quality of raw materials (e.g. fat), increasing the moisture of the product, or increasing the application rate of flavor systems. The main drawback of these solutions is availability of the materials and/or the cost.

### SUMMARY

The present disclosure provides compositions and methods for increasing the palatability of dry pet foods using sorbic acid and/or a salt thereof. The compositions and methods increase the palatability without loss of crunchiness of the dry kibbles over an extended time period. The sorbic acid and/or salt thereof can be used in the base composition of the dry pet food and/or in a coating on the dry pet food, and the sorbic acid and/or salt thereof can be used without affecting the product structure.

Accordingly, in a general embodiment, the present disclosure provides a dry pet food product comprising an ingredient selected from the group consisting of sorbic acid, a salt of sorbic acid, and a combination thereof, and further comprising an additional ingredient selected from the group consisting of a lipid, a protein, a carbohydrate, and combinations thereof.

In an embodiment, a total amount of the ingredient in the product is between 0.4 and 1.0% of the product by weight.

In an embodiment, a total amount of the ingredient in the product is between 0.5 and 1.0% of the product by weight.

In an embodiment, the ingredient is selected from the group consisting of sorbic acid, potassium sorbate, calcium sorbate, sodium sorbate and combinations thereof.

In an embodiment, the dry pet food product comprises a basal body in which at least a portion of the ingredient is present.

In an embodiment, the dry pet food product comprises a coating in which at least a portion of the ingredient is present.

In another embodiment, a method of making a dry pet food is provided. The method comprises: milling ingredients comprising an ingredient selected from the group consisting of sorbic acid, a salt of sorbic acid, and a combination thereof; extruding the milled ingredients to form an extrudate; forming kibbles from the extrudate; and drying the kibbles to form the dry pet food.

In an embodiment, the ingredient is selected from the group consisting of sorbic acid, potassium sorbate, calcium sorbate, sodium sorbate and combinations thereof.

In another embodiment, a method for making a dry pet food is provided. The method comprises: applying a coating composition to dry kibbles, the coating composition comprising an ingredient selected from the group consisting of sorbic acid, a salt of sorbic acid, and a combination thereof.

In an embodiment, the ingredient is between 0.4 and 1.0% of the coating composition by weight.

In an embodiment, the ingredient is between 0.5 and 1.0% of the coating composition by weight.

In an embodiment, the ingredient is selected from the group consisting of sorbic acid, potassium sorbate, calcium sorbate, sodium sorbate and combinations thereof.

In another embodiment, a method for increasing the palatability of dry pet food is provided. The method comprises: incorporating a palatability-enhancing amount of an ingredient selected from the group consisting of sorbic acid, potassium sorbate, calcium sorbate, sodium sorbate and combinations thereof into at least one of a basal body of the dry pet food or a coating composition of the dry pet food.

In another embodiment, a method is provided. The method comprises administering to a pet a dry food product comprising a palatability-enhancing amount of an ingredient selected from the group consisting of sorbic acid, a salt of sorbic acid, and a combination thereof.

In an embodiment, the pet is a cat, and the ingredient is between 0.4 and 1.0% of the dry food product by weight.

In an another embodiment, the pet is a cat, and the ingredient is between 0.5 and 1.0% of the dry food product by weight.

In an embodiment, the pet is a dog, and the ingredient is between 0.4 and 1.0% of the dry food product by weight.

In an another embodiment, the pet is a dog, and the ingredient is between 0.5 and 1.0% of the dry food product by weight.

In an embodiment, the dry food product comprises a basal body in which at least a portion of the ingredient is present.

In an embodiment, the dry food product comprises a coating in which at least a portion of the ingredient is present.

An advantage of the present disclosure is to improve the palatability of dry pet food.

Another advantage of the present disclosure is to use an economical and readily available compound as a palatant for pet food.

Still another advantage of the present disclosure is to improve the palatability of dry pet food without affecting the product structure.

Yet another advantage of the present disclosure is to use a compound as a palatant for dry pet foods at higher levels than those used for its recognized function as a preservative in semi-moist and wet pet foods.

An additional advantage of the present disclosure is to use a compound that is easily measured using chromatographic methods.

Another advantage of the present disclosure is to use a compound that has very low acute or chronic toxicity for animals.

Still another advantage of the present disclosure is to improve the palatability of dry pet food without relying on optimizing the quality of raw materials (e.g. fat), increasing the moisture of the product, or increasing the application rate of flavor systems.

Yet another advantage of the present disclosure is to improve the palatability of dry pet food by using a compound in the base composition of the dry pet food and/or in a coating on the dry pet food.

Additional features and advantages are described in, and will be apparent from, the following Detailed Description and the Figures.

### BRIEF DESCRIPTION OF THE DRAWINGS

FIG. 1 is a table showing the compositions used in Examples 1-13.

FIG. 2 is a table showing the palatability results of the compositions shown in FIG. 1.

FIG. 3 is a table showing the compositions used in Examples 14-23 and 27.

FIG. 4 is a table showing the compositions used in Examples 24-27.

FIG. 5 is a table showing the palatability results of the compositions shown in FIGS. 3 and 4.

FIG. 6 is a table showing detection results for various basal and coating compositions.

### DETAILED DESCRIPTION

All percentages expressed herein are by weight of the total weight of the composition unless expressed otherwise. When reference is made to the pH, values correspond to pH measured at 25° C. with standard equipment.

The term “pet” means any animal which could benefit from or enjoy the compositions provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat.

The term “pet food” means any composition intended to be consumed by a pet.

“Dry food” is pet food having a water activity less than 0.65. “Kibbles” are pellets of dry pet food. A “basal body” is a pellet of dry pet food and does not include the coating, if any. A “basal composition” is a composition processed to form the basal body. “Semi-moist food” and “intermediate moisture food” is pet food having a water activity from 0.65 to 0.8. “Wet food” is pet food having a water activity more than 0.8.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a compound” or “a method” includes a plurality of such “compounds” or “methods.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein.

The inventors surprisingly found that potassium sorbate or sorbic acid, typically used as anti-mycotic compounds in semi-moist pet foods, increased palatability of both dry cat and dry dog foods. Accordingly, the present disclosure provides compositions and methods for increasing the palatability of dry pet food, such as dry pet food kibbles. The compositions comprise at least one of sorbic acid or a salt thereof. Non-limiting examples of suitable salts of sorbic acid include potassium sorbate, calcium sorbate and sodium sorbate, each of which can be substituted for each other on an equivalent sorbate basis. In an embodiment, the composition is a dry pet food, such as a kibble, comprising a total amount of sorbic acid and/or a salt thereof between 0.3 to 1.0%; preferably 0.4 to 1%; more preferably 0.5 to 1.0% of the composition. In yet another embodiment, the composition is a coating for a dry pet food, and the coating comprises a total amount of sorbic acid and/or a salt thereof between 0.3 to 1.0%; preferably 0.4 to 1%; more preferably 0.5 to 1.0% of the coating. In an embodiment, the pet is a cat. In another embodiment, the pet is a dog.

In a preferred embodiment, the dry pet food is a complete and nutritionally balanced pet food. The dry pet food can be an extruded food product and, in an embodiment, can be for companion animals.

In an embodiment, the dry pet food can comprise at least one vitamin and/or at least one mineral. Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like.

In an embodiment, the dry pet food comprises from about 5% to about 50% crude protein. The crude protein can comprise vegetable proteins, such as whole grain wheat, whole grain corn, soybean meal, soy protein concentrate, corn gluten meal, wheat gluten, cottonseed, and peanut meal; or animal proteins, such as casein, albumin, and meat protein. Non-limiting examples of suitable meat protein include beef, pork, lamb, rabbit, equine, poultry, fish, and mixtures thereof. Non-limiting examples of suitable meat meals include rendered and ground parts from beef, pork, lamb, rabbit, equine, poultry, fish, and mixtures thereof. Non-limiting examples of suitable meat include any meat and meat by-product such as whole-carcass beef and mutton; lean pork trim; beef shanks; veal; beef and pork cheek meat; and meat by-products such as lips, tripe, hearts, tongues, mechanically deboned beef, chicken or fish, beef and pork liver, lungs, kidneys, and the like. The meat can be emulsified or particulate. In an embodiment, the meat is chicken.

In an embodiment, the dry pet food comprises from about 5% to about 40% fat. Non-limiting examples of suitable fats include animal fats and vegetable fats. Preferably the fat source is an animal fat source, for example, beef fat, pork fat, poultry fat. Vegetable oils, such as corn oil, sunflower oil, safflower oil, rape seed oil, soy bean oil, olive oil and other oils rich in monounsaturated and polyunsaturated fatty acids, and medium chain triglycerides can be used.

In an embodiment, the dry pet food comprises from about 10% to about 60% carbohydrate. Non-limiting examples of suitable carbohydrates include grains or cereals such as rice, corn, millet, sorghum, alfalfa, barley, soybeans, canola, oats, wheat, rye, triticale and mixtures thereof. The compositions can comprise other materials such as dried whey and other dairy by-products.

In an embodiment, the dry pet food comprises one or more fiber sources. The term “fiber” includes all sources of “bulk” in the food whether digestible or indigestible, soluble or insoluble, fermentable or non-fermentable. Preferred fibers are from plant sources such as marine plants but microbial sources of fiber may be used. Soluble fibers and/or insoluble fibers may be utilized. Non-limiting examples of suitable fiber sources include beet pulp (from sugar beet), gum arabic, gum talha, psyllium, rice bran, carob bean gum, citrus pulp, pectin, fructooligosaccharide, short chain oligofructose, mannanoligofructose, soy fiber, arabinogalactan, galactooligosaccharide, arabinoxylan, and mixtures thereof.

The fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may be incorporated into the dry pet food.

In some embodiments, the ash content of the dry pet food ranges from less than 1% to about 15%, preferably from about 5% to about 10%.

Selection of the amounts of each additional ingredient is known to skilled artisans. Specific amounts for each additional ingredient will depend on a variety of factors such as the ingredient included in the coating composition; the species of animal; the animal's age, body weight, general health, sex, and diet; the animal's consumption rate; the purpose for which the pet food is administered to the animal; and the like. Therefore, the identity and amounts of the additional ingredients may vary widely and may deviate from the preferred embodiments described herein.

The present disclosure also provides methods for making dry pet food. In an embodiment, the ingredients of the dry basal composition are milled, for example by a hammer mill. The milled ingredients can be extruded and expanded, and as the ropes exit the extruder they are cut into kibbles by rotating knives or another suitable cutting device. The kibbles can be dried to a moisture content less than about 20%, preferably less than about 15%, and more preferably less than about 10%.

In an embodiment, the dry kibbles can be coated with a coating composition, for example by spraying. The coating composition can include animal fat and palatants. Non limiting examples of palatants are liquid or dried hydrolyzed animal by-product parts, yeast extracts, and other flavor compounds known to those skilled in the art. In a preferred embodiment, the coating composition includes animal fat and hydrolyzed animal by-products. The kibbles can then be filled into suitable packaging which is subsequently sealed.

At least one of sorbic acid or a salt thereof is added to the dry pet food, for example in the ingredients of the dry basal composition and/or in the coating composition. If at least one of sorbic acid or a salt thereof is added to the ingredients of the dry basal composition, preferably the addition is before milling.

In an embodiment, a total amount of sorbic acid and/or a salt thereof is preferably between 0.4 to 1.0%, or more preferably between 0.5 to 1.0% of the composition, and the dry pet food is a cat food. In another embodiment, a total amount of sorbic acid and/or a salt thereof is preferably between 0.4 to 1.0%, or more preferably between 0.5 to 1.0% of the composition, and the dry pet food is a dog food. In yet another embodiment, a total amount of sorbic acid and/or a salt thereof is preferably between 0.4 to 1.0% of the coating, or more preferably between 0.5 to 1.0% of the coating.

### EXAMPLES

By way of example and not limitation, the following non-limiting examples are illustrative of various embodiments provided by the present disclosure.

### Example 1

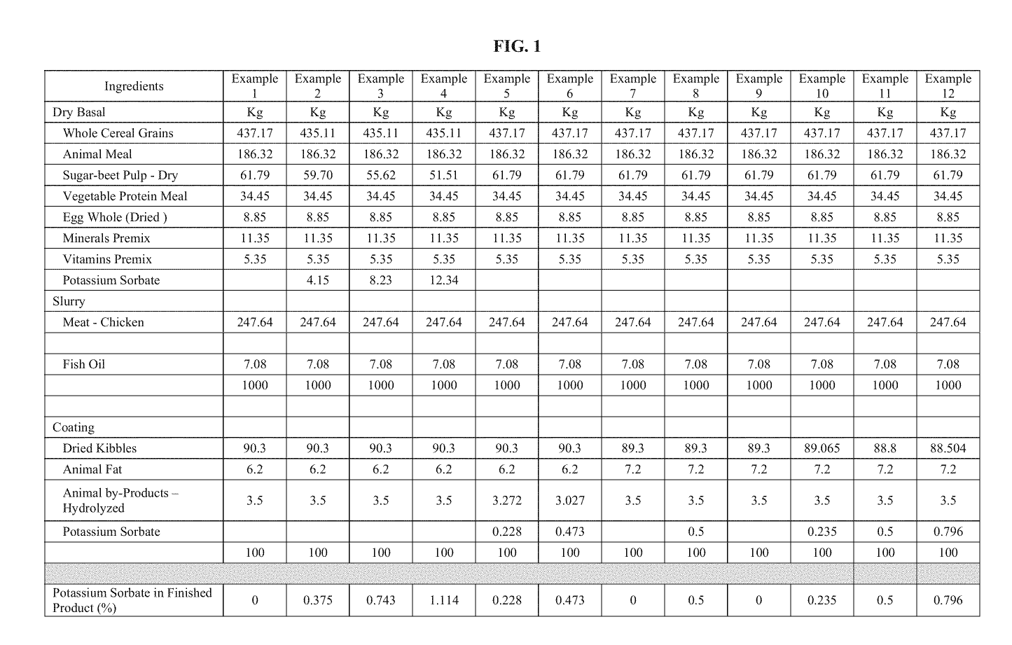

100 kg of dry dog food control product was prepared with ingredients in the proportions shown in FIG. 1 as follows. The ingredients for the dry basal (FIG. 1) were weighed into a ribbon mixer. These were blended and milled with a hammer-mill through a screen with 1.5875 mm openings and conveyed to a holding bin.

In parallel, 300 kg of chicken meat was ground with a Weiler grinder and emulsified through a Karl-Schnell emulsifier. 247.64 kg of the emulsified chicken was weighed into a steam-jacketed stainless where it was continuously stirred and maintained at 40° C. Fish oil was metered from a holding tank.

The dry basal was fed to a Clextral BC 72 twin screw extruder at 250 kg/hr along with the emulsified chicken at 83.1 kg/hr and the fish oil at 2.4 kg/hr. Water (10 L/hr) and steam (27 L/hr) was added to the ingredient mix in the extruder barrel. The extruder screw speed was 900 rpm and conditions of the molten mass maintained at 20 bars and at least 104° C. As the ropes of expanded mass exited the extruder dies, they were cut into kibbles by knives rotating at 900 rpm across the face of the dies. The kibbles were fed into a drier and dried at 125° C. for 21 minutes to a moisture content of 9.2%. 90.3 kg of the dried kibbles were weighed into a tumble coater. The coater was started and as the 6.2 Kg animal fat that was warmed to 60° C. was sprayed onto the tumbling kibbles. This was followed by 3.5 kg of liquid hydrolyzed animal by-product. The coated kibbles were tumbled for an additional 5 minutes after all the liquids were sprayed. The coated kibbles were then filled into poly bags and sealed.

### Example 2

100 kg of dry dog food test product containing 0.375% potassium sorbate was prepared using the formula in FIG. 1 as described for Example 1 with the following exceptions. Prior to hammer-milling, 4.15 kg of potassium sorbate was added to the dry basal blend. The amounts of whole cereal grains and dry sugar-beet pulp were lowered to 435.11 kg and 59.7 kg respectively to compensate.

### Example 3

100 kg of dry dog food test product containing 0.743% potassium sorbate was prepared using the formula in FIG. 1 as described for Example 1 with the following exceptions. Prior to hammer-milling, 8.23 Kg of potassium sorbate was added to the dry basal blend. The amount of whole cereal grains and dry sugar-beet pulp were lowered to 435.11 kg and 55.62 kg respectively to compensate.

### Example 4

100 kg of dry dog food test product containing 1.114% potassium sorbate was prepared using the formula in FIG. 1 as described for Example 1 with the following exceptions. Prior to hammer-milling, 12.34 Kg of potassium sorbate was added to the dry basal blend. The amounts of whole cereal grains and dry sugar-beet pulp were lowered to 435.11 kg and 51.51 kg respectively to compensate.

### Example 5

100 kg of dry dog food test product containing 0.228% potassium sorbate was prepared using the formula in FIG. 1 as described for Example 1 with the following exceptions. Instead of coating the dried kibbles with 3.5 kg liquid hydrolyzed animal by-product, they were coated with a solution containing 3.272 kg liquid hydrolyzed animal by-product and 0.228 kg potassium sorbate.

### Example 6

100 kg of dry dog food test product containing 0.473% potassium sorbate was prepared using the formula in FIG. 1 as described for Example 1 with the following exceptions. Instead of coating the dried kibbles with 3.5 kg liquid hydrolyzed animal by-product, they were coated with a solution containing 3.027 kg liquid hydrolyzed animal by-product and 0.473 kg potassium sorbate.

### Example 7

100 kg of a second dry dog food control product was prepared with ingredients in the proportions shown in FIG. 1 as described in Example 1. The difference was in the coating. 89.3 kg of the dried kibbles were sprayed with 7.2 kg animal fat at 60° C. as done in Example 1 followed by 3.5 kg liquid hydrolyzed animal by-product per Example 1.

### Example 8

100 kg of dry dog food test product containing 0.5% potassium sorbate was prepared using the formula in FIG. 1 as described for Example 7 with the following exception. Before it was sprayed onto the animal fat coated kibbles, 0.5 kg of potassium sorbate was dissolved in 3.5 kg liquid hydrolyzed animal by-product.

### Example 9

100 kg of a third dry dog food control product was prepared with ingredients in the proportions shown in FIG. 1 as described in Example 7 with different lots of ingredients.

### Example 10

100 kg of dry dog food test product containing 0.235% potassium sorbate was prepared using the formula in FIG. 1 as described for Example 9 and the same lots of ingredients with the following exception. Before it was sprayed onto the animal fat coated kibbles, 0.235 kg of potassium sorbate was dissolved in 3.5 kg liquid hydrolyzed animal by-product.

### Example 11

100 kg of dry dog food test product containing 0.5% potassium sorbate was prepared using the formula in FIG. 1 as described for Example 9 and the same lots of ingredients with the following exception. Before it was sprayed onto the animal fat coated kibbles, 0.5 kg of potassium sorbate was dissolved in 3.5 kg liquid hydrolyzed animal by-product.

### Example 12

100 kg of dry dog food test product containing 0.796% potassium sorbate was prepared using the formula in FIG. 1 as described for Example 9 and the same lots of ingredients with the following exception. Before it was sprayed onto the animal fat coated kibbles, 0.796 kg of potassium sorbate was dissolved in 3.5 kg liquid hydrolyzed animal by-product.

### Example 13

Palatability comparisons were made for test dry dog food products containing potassium sorbate and their respective controls which have no sorbate. Also palatability comparisons of all of the test and control products versus an equivalent competitive commercial dog food (1) were done. Palatability feeding tests were carried out using a 2 bowl paired comparison procedure. Pairs fed were either a test (with sorbate) versus a control (no sorbate); or the competitive commercial dog food (1) versus either the test or control products. The pair of bowls with weighed amount of products was presented to a dog for 20 minutes, or when one bowl was empty if sooner. For each bowl the difference in weight after the test was the amount consumed. For each comparison, 20 dogs were fed and the average % consumption of each product determined.

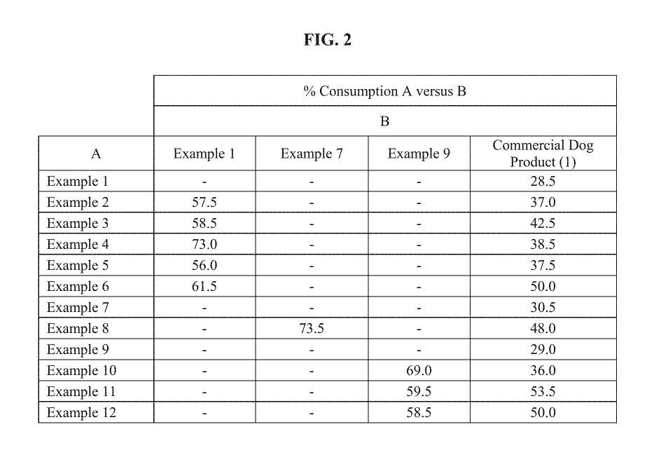

Results are shown in FIG. 2. It is clearly seen that the test products with potassium sorbate had higher consumption than their respective controls with no sorbate. Also when compared to the competitive commercial dog food (1), there was a clear increase in consumption by the test products that contained potassium sorbate over the control products with no sorbate. The palatability increase occurred whether the sorbate was in the dry basal or coated on the kibble.

### Example 14

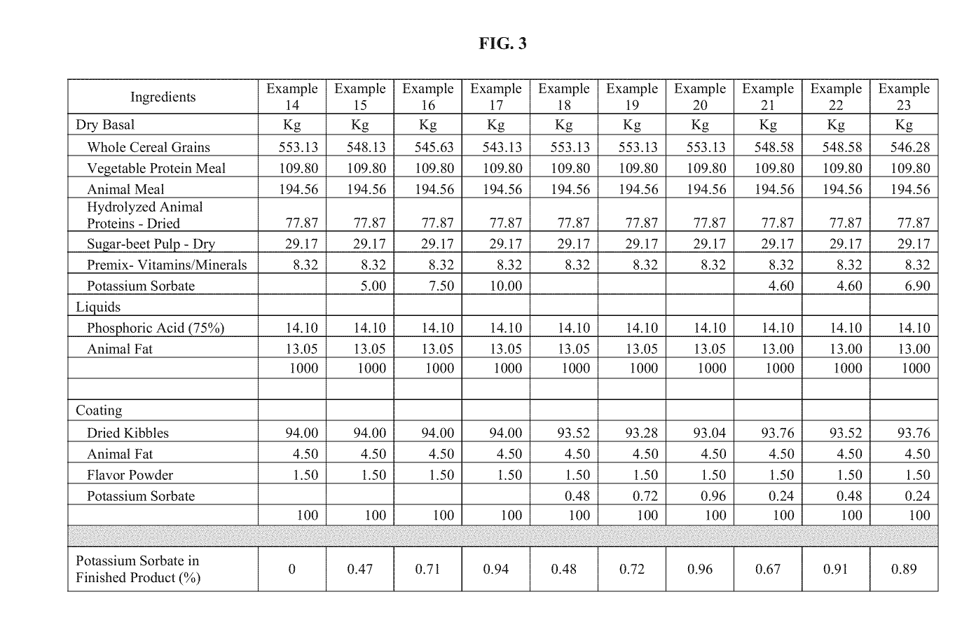

100 kg of dry cat food control product was prepared with ingredients in the proportions shown in FIG. 3 as follows. The ingredients for the dry basal (FIG. 3) were weighed into a ribbon mixer. These were blended and milled with a hammer-mill through a screen with 1.5875 mm openings and conveyed to a holding bin. Liquid animal fat and phosphoric acid (75%) were stored in separate tanks and were metered separately into the extruder. The dry basal was fed to a Clextral BC 72 twin screw extruder at 210 kg/hr along with the animal fat at 2.74 kg/hr and the phosphoric acid at 2.96 kg/hr). Water (48 kg/hr) was also added to the ingredient mix in the extruder barrel. The extruder screw speed was 150 rpm and conditions of the molten mass maintained at above 51 bars and above 92° C. As the ropes of expanded mass exited the extruder dies, they were cut into kibbles by knives rotating at 1100 rpm across the face of the dies. Parameters were adjusted to attain kibbles of wet density in the range 360-420 gL⁻¹.

The kibbles were then fed into a drier and dried at 103° C. for 11 minutes to 6.3% moisture (target 6.2-6.5%). 94 kg of the dried kibbles were weighed into a tumble coater. The coater was started and the 4.5 kg animal fat that was warmed to 60° C. was sprayed onto the tumbling kibbles. This was followed by 1.5 kg of powdered flavor blend. The coated kibbles were tumbled for an additional 5 minutes after all the liquid and powder coatings were sprayed. The coated kibbles were then filled into poly bags and sealed.

### Example 15

100 kg of dry cat food test product containing 0.47% potassium sorbate was prepared using the formula in FIG. 3 as described for Example 14 with the following exceptions. Prior to hammer-milling, 5.0 kg of potassium sorbate was added to the dry basal blend. The amount whole cereal grains was lowered to 548.13 kg to compensate.

### Example 16

100 kg of dry cat food test product containing 0.71% potassium sorbate was prepared using the formula in FIG. 3 as described for Example 14 with the following exceptions. Prior to hammer-milling, 7.5 Kg of potassium sorbate was added to the dry basal blend. The amount whole cereal grains was lowered to 545.63 kg to compensate.

### Example 17

100 kg of dry cat food test product containing 0.94% potassium sorbate was prepared using the formula in FIG. 3 as described for Example 14 with the following exceptions. Prior to hammer-milling, 10 kg of potassium sorbate was added to the dry basal blend. The amount whole cereal grains was lowered to 543.13 kg to compensate.

### Example 18

100 kg of dry cat food test product containing 0.48% potassium sorbate was prepared using the formula in FIG. 3 as described for Example 14 with the following exceptions. A mixture of 0.48 kg finely ground potassium sorbate and 1.5 kg powdered flavor was made. 93.52 kg of the dried kibbles were weighed into a tumble coater. As done in Example 14, the coater was started and the 4.5 kg animal fat that was warmed to 60° C. was sprayed onto the tumbling kibbles. This was followed by the powdered mixture. The coated kibbles were tumbled for an additional 5 minutes after all the liquid and powder coatings were sprayed. The coated kibbles were then filled into poly bags and sealed.

### Example 19

100 kg of dry cat food test product containing 0.72% potassium sorbate was prepared using the formula in FIG. 3 as described for Example 14 with the following exceptions. A mixture of 0.72 kg finely ground potassium sorbate and 1.5 kg powdered flavor was made. 93.28 kg of the dried kibbles were weighed into a tumble coater. Coating of the kibbles and packaging were as per Example 18.

### Example 20

100 kg of dry cat food test product containing 0.96% potassium sorbate was prepared using the formula in FIG. 3 as described for Example 14 with the following exceptions. A mixture of 0.96 kg finely ground potassium sorbate and 1.5 kg powdered flavor was made. 93.04 kg of the dried kibbles were weighed into a tumble coater. Coating of the kibbles and packaging were as per Example 18.

### Example 21

100 kg of dry cat food test product containing 0.67% potassium sorbate was prepared using the formula in FIG. 3. For this product, 0.43% sorbate was added via the uncoated kibbles as described for Example 15 using ingredient quantities shown in FIG. 3 for dry basal; and 0.24% sorbate via the coating as per Example 18 using ingredient quantities shown in FIG. 3 for coating.

### Example 22

100 kg of dry cat food test product containing 0.91% potassium sorbate was prepared using the formula in FIG. 3. For this product, 0.43% sorbate was added via the uncoated kibbles as described for example 15 using ingredient quantities shown in FIG. 3 for dry basal; and 0.48% sorbate via the coating as per Example 18 using ingredient quantities shown in FIG. 3 for coating.

### Example 23

100 kg of dry cat food test product containing 0.89% potassium sorbate was prepared using the formula in FIG. 3. For this product, 0.65% sorbate was added via the uncoated kibbles as described for Example 15 using ingredient quantities shown in FIG. 3 for dry basal; and 0.24% sorbate via the coating as per Example 18 using ingredient quantities shown in FIG. 3 for coating.

### Example 24

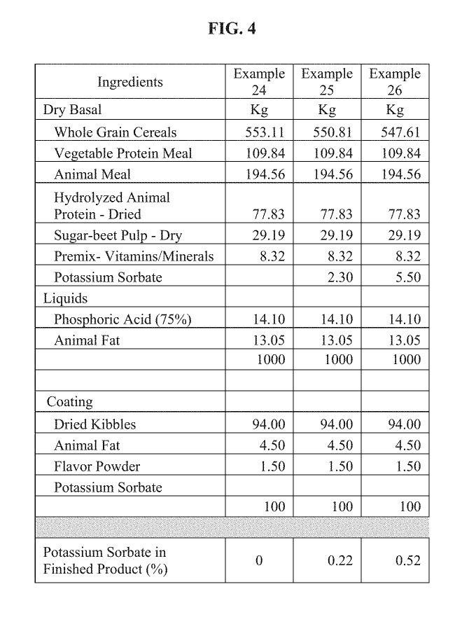

100 kg of a second control dry cat food product was prepared with ingredients in the proportions shown in FIG. 4 as for Example 14 with the following exceptions in order to attain kibbles of wet density in the range 360-420 gL⁻¹ and 6.4% after drying. The dry basal was fed to a Clextral BC 72 twin screw extruder at 230 kg/hr along with the animal fat at 3.0 kg/hr and the phosphoric acid at 3.24 Kg/hr). Water (53 kg/hr) was also added to the ingredient mix in the extruder barrel. The extruder screw speed was 190 rpm and conditions of the molten mass maintained at above 38 bars and above 101° C. As the ropes of expanded mass exited the extruder dies, they were cut into kibbles by knives rotating at 2100 rpm across the face of the dies. The kibbles were then fed into a drier and dried at 95° C. for 10 minutes to 6.4% moisture.

### Example 25

100 kg of dry cat food test product containing 0.22% potassium sorbate via the dry basal was prepared using the formula in FIG. 4 as described for Example 24 with the following exceptions. Prior to hammer-milling, 2.30 kg of potassium sorbate was added to the dry basal blend. The amount whole cereal grains was lowered to 550.81 kg to compensate.

### Example 26

100 kg of dry cat food test product containing 0.52% potassium sorbate via the dry basal was prepared using the formula in FIG. 4 as described for Example 24 with the following exceptions. Prior to hammer-milling, 5.50 kg of potassium sorbate was added to the dry basal blend. The amount whole cereal grains was lowered to 547.61 kg to compensate.

### Example 27

Palatability comparisons were made for test dry cat food products containing potassium sorbate and their respective controls which have no sorbate. Also palatability comparisons of all of the test and control products versus two different competitive commercial cat foods (1) and (2) were done. Palatability feeding tests were carried out using a 2 bowl paired comparison procedure. Pairs fed were either a test (with sorbate) versus a control (no sorbate); or the competitive commercial cat food (1) or commercial cat food (2) versus either the test or control products. The pair of bowls with weighed amount of products was presented to a cat for 19 hours. For each bowl the difference in weight after the test was the amount consumed. For each comparison, 40 cats were fed and the average % consumption of each product determined.

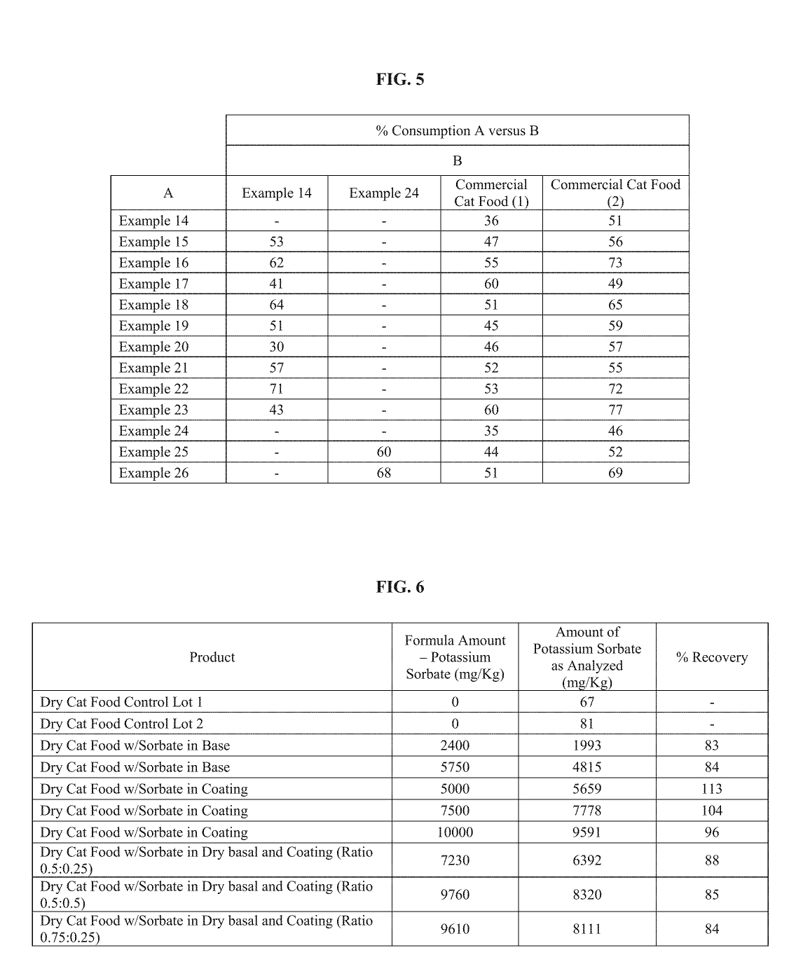

Results are shown in FIG. 5. It is clearly seen that the test products with potassium sorbate had higher consumption than their respective controls with no sorbate. Also when compared to the competitive commercial cat foods (1) and (2), there was a clear increase in consumption by the test products that contained potassium sorbate over the control products with no sorbate. The palatability increase occurred whether the sorbate was in the dry basal or coated on the kibble (except at the highest sorbate level, 0.96%, in coating only).

### Example 28

Potassium sorbate in dry cat food cat food was determined by HPLC. Separation of the sorbate was done with a diphenyl-silica column and an elution gradient that was prepared with 0.05% aqueous trifluoroacetic acid and methanol (97.5:2.5 v/v). Detection was with a UV detector. Quantification was carried out by external calibration (reference method, International Federation of Fruit Juice Producers Method of Analysis #63, January 1995). The results are shown in FIG. 6. It is seen that potassium sorbate can be detected with a recovery rate of at least 80%.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for increasing the palatability of dry pet food comprising: incorporating 0.5 weight % to 1.0 weight % of a salt of sorbic acid selected from the group consisting of potassium sorbate, calcium sorbate, sodium sorbate and combinations thereof, into at least one of a basal body of the dry pet food or a coating composition of the dry pet food.

2. The method of claim 1 wherein the salt of sorbic acid is potassium sorbate.

3. The method of claim 1, wherein at least a portion of the salt of sorbic acid is present in the basal body.

4. The method of claim 1, wherein at least a portion of the salt of sorbic acid is present in the coating.

5. The method of claim 1, wherein the salt of sorbic acid is in both the basal body and the coating.

6. The method of claim 1, wherein the dry pet food is a cat food.

7. The method of claim 1, wherein the dry pet food is a dog food.
